(19) United States
(12) Patent Application Publication
(10) Pub. No.: US 2016/0156753 A1
(43) Pub. Date: Jun. 2, 2016

(54) ENHANCED GPRS TUNNEL PROTOCOL TUNNEL ENDPOINT IDENTIFIER

(71) Applicant: NOKIA SOLUTIONS AND NETWORKS OY, Espoo (FI)

(72) Inventor: Giorgi GULBANI, Espoo (FI)

(21) Appl. No.: 14/787,306

(22) PCT Filed: Apr. 30, 2013
(86) PCT No.: PCT/EP2013/059009

§ 371 Date: Oct. 27, 2015

(51) Int. Cl. H04L 29/08

(52) U.S. Cl. CPC H04L 69/325; H04L 69/326

(57) ABSTRACT

The present invention addresses method, apparatus and computer program product for providing an enhanced GPRS Tunnel Protocol Tunnel Endpoint Identifier. There is proposed an extension for GTPv1-U TEID-U values by using extended TEID-U range across Gn/Gp interfaces (tunnel setup with GTPv1-C).

There is another proposal for extending both GTPv2 TEID-C values and also linked GTPv1-U TEID-U values by using extended TEID ranges across GTP-based S5/S8 and S2b/S2a interfaces (tunnel setup with GTPv2), by using extended TEID-U range across GTP-based S1-U interface (tunnel setup via S11) and/or by using extended TEID-U range across GTP-based S4-U, or S12 interfaces (tunnel setup via S4-C).

### FIELD OF THE INVENTION

The present invention generally relates to wireless communication networks, and more specifically relates to a method, apparatus and computer program product for providing an enhanced General Packet Radio Service GPRS Tunnel Protocol GTP Tunnel Endpoint Identifier TEID.

### BACKGROUND

Mobile data transmission and data services are constantly making progress, wherein such services provide various communication services, such as voice, video, packet data, messaging, broadcast, etc. In recent years, Long Term Evolution LTE™ has been specified, which uses the Evolved Universal Terrestrial Radio Access Network E-UTRAN as radio communication architecture according to 3GPP specification.

Such 3GPP network elements, which use GTP-based interfaces, use a TEID value in the GTP header for finding internal process that handle the given communication. During a session setup or modification, each GTP entity sends an own control plane TEID value (TEID-C) to a GTP-C peer, and receives a peer's control plane TEID-C value. In addition to that, GTP entities that support GTP-based user plane, must also send and receive user plane TEID-U values with control plane messages. After such exchange, GTP-U entities (evolved Node B—eNodeB, Serving Gateway—SGW, Packet Gateway—PGW, Radio Network Controller—RNC, Serving GPRS Support Node—SGSN, Gateway GPRS Support—Node GGSN) can exchange uplink UL and downlink DL GTP-U payload. Each user plane bearer is assigned TEID-U value, which is unique in the given GTP-U entity.

Currently, both GTPv1 (GTP Version 1) and GTPv2 (GTP Version 2) TEID values are represented with a 32 bits long number, which provides for around 4 billion values. Modern GTP-U entities typically run on a distributed hardware (e.g. Advanced Telecommunications Computing Architecture ATCA), which is capable of supporting large number of user plane bearers, represented by TEID-Us. Each logical entity (node) in a distributed GTP-U entity typically can handle few millions of TEID-Us, which is significantly less than 4 billion. The problem however is that in a distributed architecture more and more bits from TEID range are required for finding the correct node in a simpler and faster way. So, 32 bits long number no longer looks sufficient and should be extended.

Hence, in view of the above drawbacks, there is a need for providing an enhanced GPRS Tunnel Protocol Tunnel Endpoint Identifier.

### SUMMARY OF THE INVENTION

Therefore, in order to overcome the drawbacks of the prior art, it is an object underlying the present invention to provide an enhanced GPRS Tunnel Protocol Tunnel Endpoint Identifier.

In particular, it is an object of the present invention to provide a method, apparatus and computer program product for providing an enhanced GPRS Tunnel Protocol Tunnel Endpoint Identifier.

According to the present invention, there is proposed an extension for GTPv1 and GTPv2 TEID values.

According to a first aspect of the present invention, there is provided a method, comprising composing a General Packet Radio Service Tunnel Protocol header, and causing transmission of the General Packet Radio Service Tunnel Protocol header to a network element, wherein the General Packet Radio Service Tunnel Protocol header includes at least one first field comprising Tunnel Endpoint Identifier information, and at least one second field comprising extended user plane Tunnel Endpoint Identifier information.

According to a second aspect of the present invention, there is provided an apparatus, which comprises a processing means adapted to compose a General Packet Radio Service Tunnel Protocol header, and a transmission means adapted to cause transmission of the General Packet Radio Service Tunnel Protocol header to a network element, wherein the General Packet Radio Service Tunnel Protocol header includes at least one first field comprising Tunnel Endpoint Identifier information, and at least one second field comprising extended user plane Tunnel Endpoint Identifier information.

According to a third aspect of the present invention, there is provided a computer program product comprising computer-executable components which, when the program is run, are configured to carry out the method according to the first aspect.

Advantageous further developments or modifications of the aforementioned exemplary aspects of the present invention are set out in the dependent claims.

According to certain embodiments of the present invention, the extension is achieved by using extended TEID-U range across Gn/Gp interfaces (tunnel setup with GTPv1-C).

According to certain embodiments of the present invention, the extension is achieved by using extended TEID-U range across GTP-based S5/S8 and S2b/S2a interfaces (tunnel setup with GTPv2).

Further, according to certain embodiments of the present invention, the extension is achieved by using extended TEID-U range across GTP-based S1-U interface (tunnel setup with GTPv2 via S11 and with S1AP across S1-MME).

Still further, according to certain embodiments of the present invention, the extension is achieved by using extended TEID-U range across GTP-based S4 interfaces (tunnel setup with GTPv2).

Further, according to certain embodiments of the present invention, the extension is achieved by using extended TEID-U range across GTP-based S12 interface (tunnel setup with GTPv2 via S4-C and with RANAP across Iu-PS).

### BRIEF DESCRIPTION OF DRAWINGS

For a more complete understanding of example embodiments of the present invention, reference is now made to the following descriptions taken in connection with the accompanying drawings in which:

FIG. 1 schematically shows a conventional Tunnel Endpoint Identifier Data I Information Element according to 3GPP TS 29.060 specification;

FIG. 2 schematically shows an outline of a GTP Header according to 3GPP TS 29.060 specification;

FIG. 3 schematically shows an updated outline of a GTP Header according to certain embodiments of the present invention;

FIG. 4 schematically shows a conventional Fully Qualified Tunnel Endpoint Identifier (F-TEID) according to 3GPP TS 29.274 specification;

FIG. 5 schematically shows a Fully Qualified Tunnel Endpoint Identifier (F-TEID) according to certain embodiments of the present invention;

FIG. 6 schematically shows a Node Features IE according to 3GPP TS 29.274 specification;

FIG. 7 illustrates a method according to certain embodiments of the invention; and

FIG. 8 schematically illustrates an apparatus according to certain embodiments of the invention.

### DESCRIPTION OF EXEMPLARY EMBODIMENTS

Exemplary aspects of the present invention will be described herein below. More specifically, exemplary aspects of the present invention are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

### Solution for Legacy, GTPv1-C Based Packet Switched PS Domain Networks

Firstly, a solution for the serving gateway SGW and packet gateway PGW according to certain embodiments of the present invention is described.

That is, according to certain embodiments of the present invention, an extended TEID-U range across Gn/Gp interfaces (tunnel setup with GTPv1-C) is used.

In the following, the extended TEID coding according to the present embodiment is described.

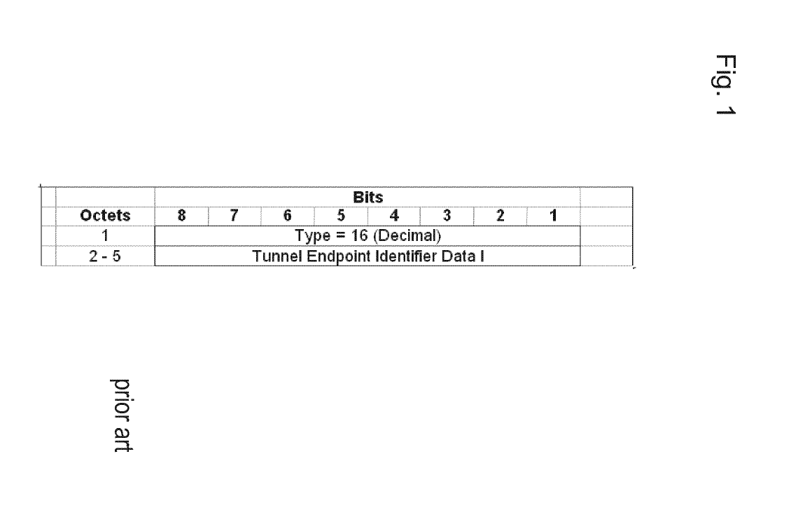

FIG. 1 shows a Tunnel Endpoint Identifier Data I Information Element specified according to 3GPP TS 29.060. During a session setup and modification, user plane TEID values are exchanged between Gn/Gp SGSN and GGSN. So, there is no room for backward compatible amendments to this IE type.

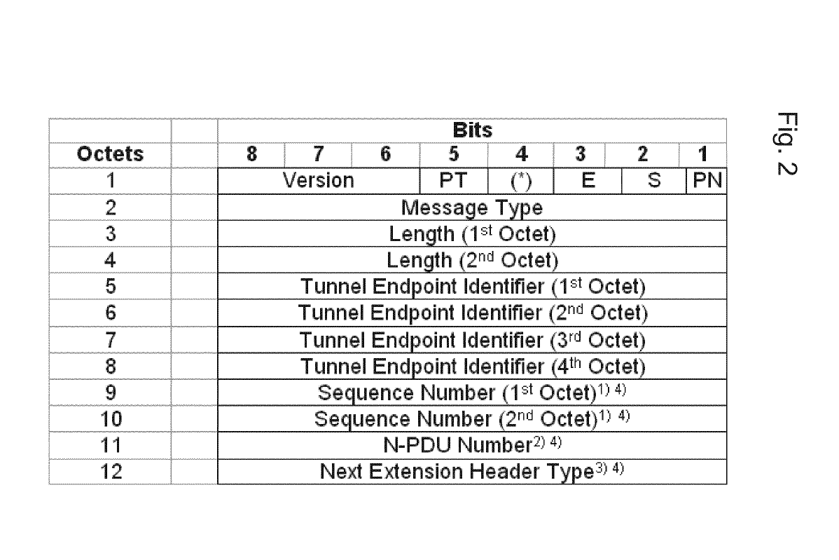

For extending TEID value range, either N-PDU Number field in GTPv1 header can be used, as illustrated in FIG. 2, or a new Extension Header may be specified (not shown, because this alternative looks less attractive).

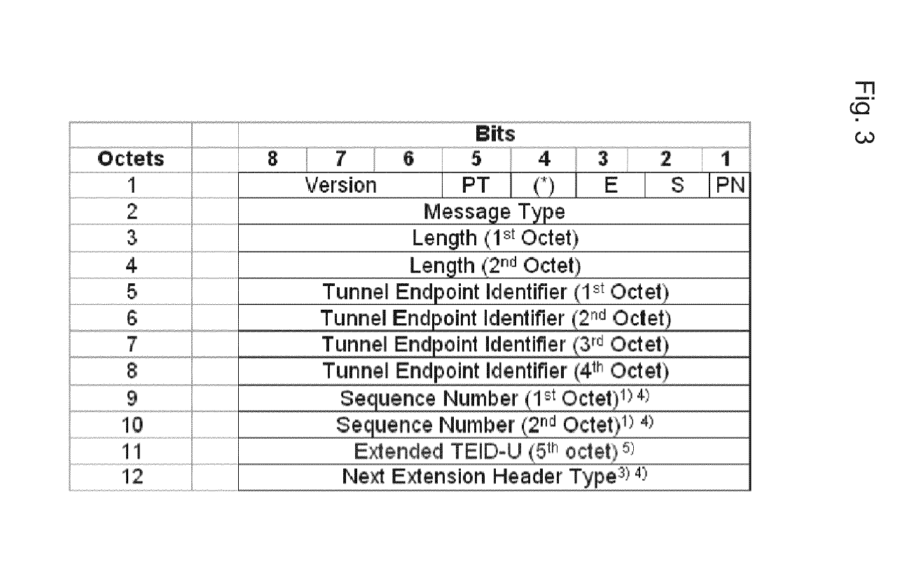

FIG. 2 schematically shows an outline of the GTP Header, and FIG. 3 shows an updated outline of the GTP Header, with the changed semantics of the octet 11. In FIG. 2, as well as in FIG. 3, the following notes (i.e. * and ¹⁾ to ⁴⁾) apply:
(*): This bit is a spare bit. It shall be sent as “0”. The receiver shall not evaluate this bit.
NOTE ¹⁾: This field shall only be evaluated when indicated by the S flag set to 1.
NOTE ²⁾: This field shall only be evaluated when indicated by the PN flag set to 1.
NOTE ³⁾: This field shall only be evaluated when indicated by the E flag set to 1.
NOTE ⁴⁾: This field shall be present if and only if any one or more of the S, PN and E flags are set.

Using N-PDU Number field may be more appealing, because SGSN never sends anything meaningful with N-PDU Number field to GGSN and vice versa. The only limitation with this approach is that Create/Update packet data protocol PDP Context Request messages contain two TEID values: TEID-C and TEID-U. So, N-PDU Number field must be used for extending only TEID-U range. So, semantically modified GTPv1 header may look as is schematically shown in FIG. 3.

In FIG. 3, NOTE ⁵⁾ defines that this field shall be present in GTPv1-C and GTPv1-U message headers exchanged by SGSN and GGSN if both SGSN and GGSN support Extended TEID-U feature.

The above solution will extend TEID-U range to 40 bits (up to 1 trillion values) and requires low standardization efforts.

Next, exchanging extended TEIDs via control plane according to the present embodiment is described.

Without Direct Tunnel deployment, it is easy to implement and use the new feature for nonroaming cases. Only a few of SGSNs and GGSNs are provided in a public land mobile network PLMN, so that an operator can easily configure SGSNs (which support the extended TEID-U feature) to know which GGSNs also support this feature. So, such SGSN will send own extended TEID-U only to such GGSNs as follows:
4 octets of the SGSN's own TEID-U with “SGSN Address for user traffic” IE in that Create/Update PDP Context Request message.
And the fifth octet of the SGSN's TEID-U is in the N-PDU Number field of the GTPv1-C header of the message.

GGSN will return own extended TEID-U in a similar way:
4 octets of the GGSN's own TEID-U with “GGSN Address for user traffic” IE in that Create/Update PDP Context Response message.
And the fifth octet of the GGSN's TEID-U is in the N-PDU Number field of the GTPv1-C header of the message.

After this, G-PDU (GTP-U user plane packets) headers between such SGSN and GGSN will contain five octets long destination TEID-U in octets 5 to 8 and 11.

If Direct Tunnel is used, then SGSN needs to know which Radio Network Controller RNC and which GGSNs support the feature to negotiate extended TEID-Us between these. A solution for such scenarios may not be practically feasible, because instead of upgrading Gn/Gp SGSNs to new features, operators typically upgrade them to support S4-SGSn functionality.

### Solution for GTPv2 Based Evolved Packet Core EPC Networks

Further, according to certain embodiments of the present invention, an extended TEID-U range across GTP-based S5/S8 and S2b/S2a interfaces (tunnel setup with GTPv2) is used.

In the following, the extended TEID coding according to the present embodiment is described.

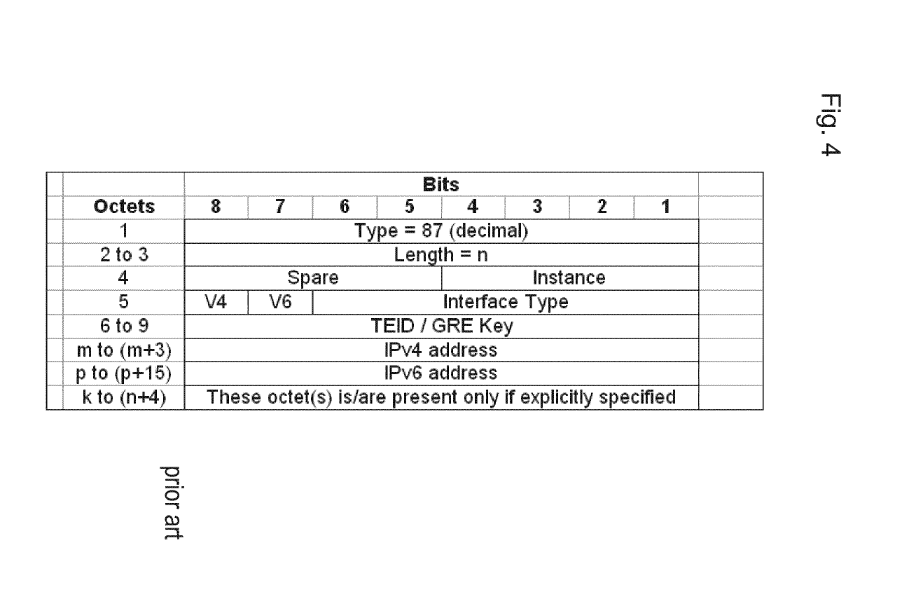

During a session setup and modification, user plane F-TEID values are exchanged between SGW/ePDG/Trusted-AP and PGW. Currently, 3GPP TS 29.274 specifies the coding of this IE as is schematically shown in FIG. 4.

FIG. 4 shows a conventional Fully Qualified Tunnel Endpoint Identifier (F-TEID).

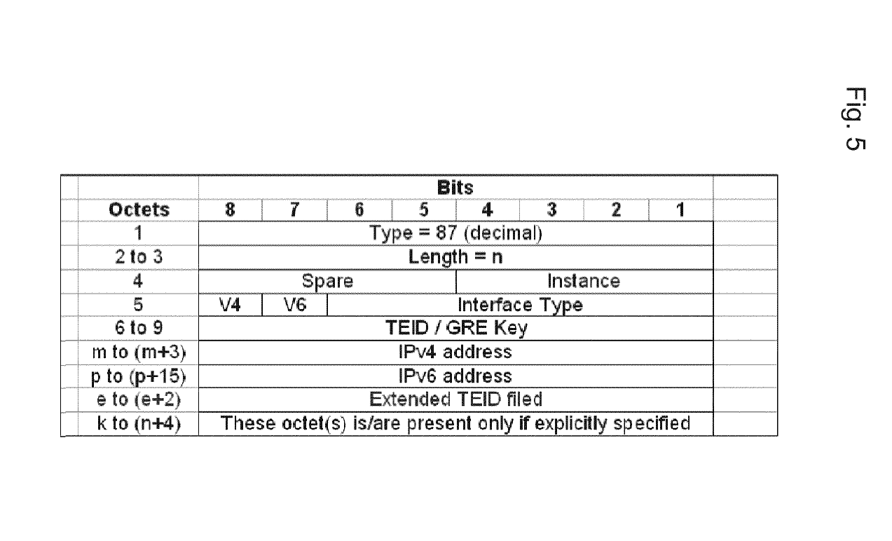

According to certain embodiments of the invention the TEID field (octets 6 to 9) is extended with three octets from k to (k+2), so that the overall F-TEID value becomes a multiple of 4, as is illustrated in FIG. 5.

FIG. 5 shows an updated Fully Qualified Tunnel Endpoint Identifier (F-TEID) according to certain embodiments of the present invention with the adapted octets e to (e+2).

As is shown in FIG. 5, if only IPv4 address is present, the extended TEID filed will span octets 10 to 12. If only IPv6 is present, then the extended TEID filed will span octets 26 to 28. If both IPv4 and IPv6 addresses are present, then the extended TEID filed will span octets 30 to 32.

So, the overall length of the TEID field will become 54 bits, which is a value range up to around 72×10̂15.

Backward compatibility requires that the Length field (octets 2 to 3) should be used for telling new coding form the old one. Legacy GTPv2 entities will simply ignore extended TEID filed in octets e to (e+2). Other option could be using one of the spare bits in octet 4, but many implementations have hard coded handling of the first, common 4 octets of GTPv2 IEs.

Next, exchanging extended TEIDs via control plane according to the present embodiment is described.

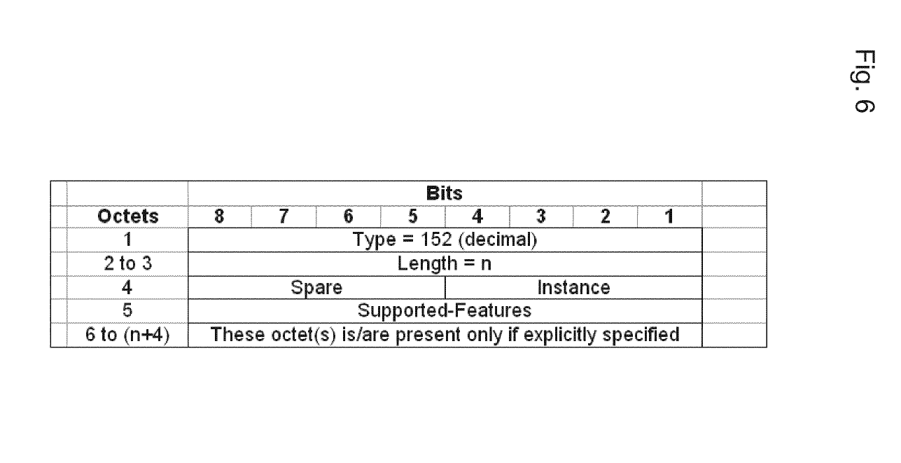

All GTPv2 messages across S5/S8 and S2b/S2a interfaces contain a F-TEID field. It is desirable that GTP-C entity, which initiates procedure, knows if the peer supports extended TEID, or not. This can be achieved by adding a new flag to GTPv2 Node Features IE type, as is schematically shown in FIG. 6.

FIG. 6 shows a Node Features Information Element IE according to 3GPP TS 29.274 specification.

The following table shows the Node Features on GTPv2 interfaces according to certain embodiments of the present invention, with the new feature octet/bit 5/4 comprising the extended TEID support indication.

| Feature | | | |
|---|---|---|---|
| Octet/Bit | Feature | Interface | Description |
| 5/1 | PRN | S11, S4 | PGW Restart Notification. |
| | | | If both the SGW and the MME/S4-SGSN |
| | | | support this feature, the SGW shall send |
| | | | PGW Restart Notification message to the |
| | | | MME/S4-SGSN when the SGW detects |
| | | | that the peer PGW has restarted, and the |
| | | | SGW may send PGW Restart Notification |
| | | | message when the SGW detects that the |
| | | | peer PGW has failed and not restarted, as |
| | | | specified in subclause 7.9.5. |
| 5/2 | MABR | S11 | Modify Access Bearers Request. |
| | | | If both the SGW and the MME support this |
| | | | feature, the MME may modify the S1-U |
| | | | bearers of all the PDN connections of the |
| | | | UE by sending a Modify Access Bearers |
| | | | Request message as specified in sub- |
| | | | clause 7.2.24. |
| 5/3 | NTSR | S11/S4 | Network Triggered Service Restoration |
| | | | procedure. |
| | | | If both the SGW and the MME/S4-SGSN |
| | | | support this feature (see 3GPP TS 23.007 |
| | | | [17]), the SGW shall send a Downlink Data |
| | | | Notification message including the IMSI |
| | | | to the MME/S4-SGSN on the TEID 0 as |
| | | | part of a network triggered service restoration |
| | | | procedure. |
| 5/4 | ETSI | S2a, S2b, S5, S8 | Extended TEID support indication. |
| | | | If both the SGW and the PGW support this |
| | | | feature, the SGW/ePDG/Trusted-AP shall |
| | | | send an Extended TEID filed with F-TEID |
| | | | IE to PGW and vice versa. |

A further option is sending an interim extended TEID and awaiting for the response. If the response does not contain extended TEID, this means the peer does not support the feature and the originator needs to revert to 32 bits long TEIDs. This option is less appealing.

Still further, according to certain embodiments of the present invention, an extended TEID-U range across GTP-based S1-U interface (tunnel setup via S11) is used.

In the following, the extended TEID coding according to the present embodiment is described.

During a session setup and modification, user plane F-TEID values must be exchanged between SGW and eNodeB, but these nodes do not have a direct control plane interface. In order to setup user plane between SGW and eNodeB (S1-U), the Mobility Management Entity MME needs to communicate with SGW across S11 (GTPv2) and also with eNodeB across S1-MME (S1 Application Protocol S1AP) interfaces.

The extended TEID coding for GTPv2 is the same as in the previous embodiment. However, the S1AP part is different. 3GPP TS 36.413 specifies GTP-TEID ASN-1 type, which is 4 octets long:
GTP-TEID::=OCTET STRING (SIZE (4))

So, either new ASN.1 type should be added to 3GPP TS 36.413, or the exiting type may be modified. Therefore, either of the following may be adapted:
GTP-TEIDext::=OCTET STRING (SIZE (7))
GTP-TEID::=OCTET STRING (SIZE (4 . . . 7))
GTP-TEID::=OCTET STRING

Next, exchanging extended TEIDs via control plane according to the present embodiment is described.

The GTPv2 part is the same as in preceding embodiment. The only difference is that ‘S11’ must be added to “52a, S2b, S5, S8” in the above table.

The problem with S11 interface solution is that before sending Create Session Request to an SGW, the MME must know if the eNodeB supports the extended TEIDs. The reason is that if the SGW returns an extended TEID-U with Create Session Response, but the eNodeb does not support that, then the subsequent E-RAB SETUP REQUEST to eNodeB will fail. This problem can be solved by configuring the MME with the knowledge that all eNodeBs in the PLMN support this feature. Otherwise, the MME should never send an ‘ETSI’ flag to the SGW.

Another alternative is configuring the MME with a knowledge which eNodeB supports the feature and which does not.

Still further, according to certain embodiments of the present invention, an extended TEID-U range across GTP-based S4-U, or S12 interfaces (tunnel setup via S4-C) is used.

In the following, the extended TEID coding according to the present embodiment is described.

During a session setup and modification, user plane F-TEID values must be exchanged between SGW and S4-SGSN or RNC. In order to setup user plane between SGW and RNC (S12), the S4-SGSN needs to communicate with SGW across S4 (GTPv2) and also with RNC across Iu-PS (RANAP) interfaces.

The extended TEID coding for GTPv2 is the same as in the previous embodiment. However, the RANAP part is different. 3GPP TS 25.413 specifies GTP-TEI ASN.1 type, which is 4 octets long:
GTP-TEI::=OCTET STRING (SIZE (4))

So, either new ASN.1 type may be added to 3GPP TS 25.413, or the exiting type may be modified. Therefore, either of the following may be adapted:
GTP-TEIext::=OCTET STRING (SIZE (7))
GTP-TEI::=OCTET STRING (SIZE (4 . . . 7))
GTP-TEI::=OCTET STRING

Next, exchanging extended TEIDs via control plane according to the present embodiment is described.

GTPv2 part is the same as in the previous embodiment. The only difference is that ‘S4’ and ‘S12’ must be added to “S2a, S2b, S5, S8” in the above Table.

The problem with S12 interface solution is that before sending a Create Session Request to an SGW, the S4-SGSN must know if the RNC supports the extended TEIDs. The reason is that if the SGW returns extended TEID-U with Create Session Response, but RNC does not support that, then the subsequent RAB SETUP REQUEST to RNC will fail. This problem can be solved by configuring the S4-SGSN with the knowledge that all RNCs in the PLMN support this feature. Otherwise, the S4-SGSN should never send ‘ETSI’ flag to SGW.

Another alternative is to configure the S4-SGSN with a knowledge which RNC supports the feature an, but that's quite challenging, because of a large number of RNCs.

Matters that are Common for GTPv1 and GTPv2 Based Networks

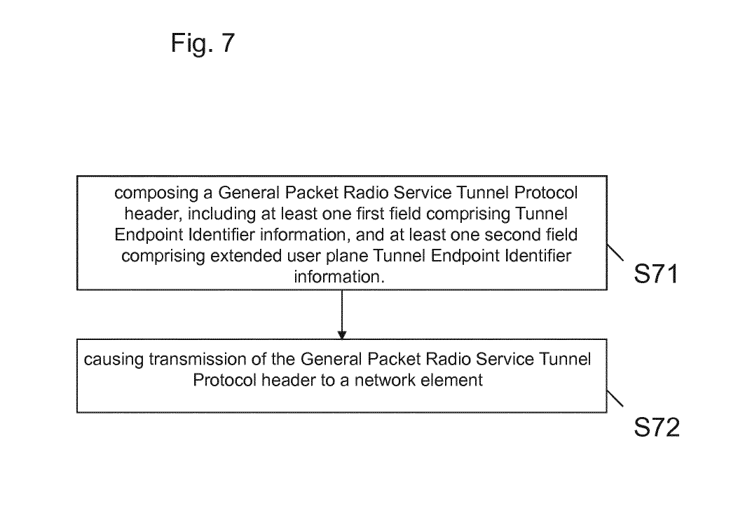

FIG. 7 shows a principle flowchart of an example for a method according to certain embodiments of the present invention.

In Step S71, a General Packet Radio Service Tunnel Protocol header is composed, which includes at least one first field comprising Tunnel Endpoint Identifier information, and at least one second field comprising extended user plane Tunnel Endpoint Identifier information.

In Step S72, transmission of the General Packet Radio Service Tunnel Protocol header to a network element is caused.

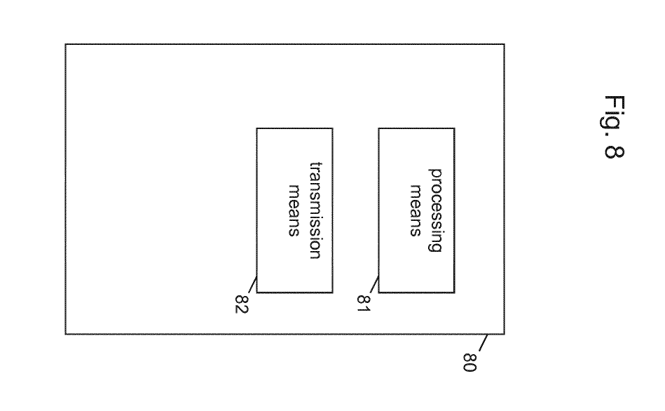

FIG. 8 shows a principle configuration of an example for an apparatus according to certain embodiments of the present invention.

The apparatus 80 comprises a processing means 81 adapted to compose a General Packet Radio Service Tunnel Protocol header, and a transmission means 82 adapted to cause transmission of the General Packet Radio Service Tunnel Protocol header to a network element. The General Packet Radio Service Tunnel Protocol header includes at least one first field comprising Tunnel Endpoint Identifier information, and at least one second field comprising extended user plane Tunnel Endpoint Identifier information.

Implementations may support all of the above options, but the simplest ones are:
Using extended TEID-U range across Gn/Gp interfaces, if Direct Tunnel is not used.
Using extended TEID-U range across GTP-based S5/S8 and S2b/S2a interfaces.
Using extended TEID-U range across GTP-based S4-U interface.

The present invention addresses method, apparatus and computer program product for providing an enhanced GPRS Tunnel Protocol Tunnel Endpoint Identifier. There is proposed an extension for GTPv1-U TEID-U values by using extended TEID-U range across Gn/Gp interfaces (tunnel setup with GTPv1-C).

There is another proposal for extending both GTPv2 TEID-C values and also linked GTPv1-U TEID-U values by using extended TEID ranges across GTP-based S5/S8 and S2b/S2a interfaces (tunnel setup with GTPv2), by using extended TEID-U range across GTP-based S1-U interface (tunnel setup via S11) and/or by using extended TEID-U range across GTP-based S4-U, or S12 interfaces (tunnel setup via S4-C).

It is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The present invention relates in particular but without limitation to mobile communications, for example to environments under LTE™ or LTE-Advanced, and can advantageously be implemented also in controllers, base stations, user equipments or smart phones, or personal computers connectable to such networks. That is, it can be implemented e.g. as/in chipsets to connected devices.

If desired, the different functions discussed herein may be performed in a different order and/or concurrently with each other. Furthermore, if desired, one or more of the abovedescribed functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following meanings for the abbreviations used in this specification apply:

### GPRS General Packet Radio Service

### TEID Tunnel Endpoint Identifier

### GTP GPRS Tunnel Protocol

### LTE Long Term Evolution

### 3GPP 3^{rd} Generation Partnership Project

eNodeB evolved Node B (base station in LTE)

### PGW Packet Gateway

### SGW Serving Gateway

### SGSN Serving GPRS Support Node

### GGSN Gateway GPRS Support Node

### PDP Packet Data Protocol

### PLMN Public Land Mobile Network

### IE Information Element

### RNC Radio Network Controller

### MME Mobility Management Entity

IPv4 Internet Protocol version 4
IPv6 Internet Protocol version 6

1. A method, comprising:
composing a General Packet Radio Service Tunnel Protocol header; and
causing transmission of the General Packet Radio Service Tunnel Protocol header to a network element,
wherein the General Packet Radio Service Tunnel Protocol header includes at least one first field comprising Tunnel Endpoint Identifier information, and at least one second field comprising extended user plane Tunnel Endpoint Identifier information.

2. The method according to claim 1, wherein
the network element is a Serving General Packet Radio Service Support Node or a Gateway General Packet Radio Service Support Node; and
the interface is a Gn/Gp interface.

3. The method according to claim 1, wherein the second field is the Network Protocol Data Unit number field.

4. The method according to claim 1, wherein the General Packet Radio Service Tunnel Protocol header indicates a tunnel setup with General Packet Radio Service Tunnel Protocol Version 1.

5. The method according to claim 1, wherein
the network element is at least one of a Serving Gateway, an Evolved Packet Data Gateway, a trusted Access Point, and a Packet Gateway; and
the interface is one of a S5/S8 interface and a S2b/S2a interface.

6. The method according to claim 1, wherein
the network element is one of a Serving Gateway, a base station and a Mobility Management Entity; and
the interface is a S1-U interface at a tunnel setup via a S11 interface.

7. The method according to claim 1, wherein
the network element is one of a Serving Gateway, a Serving General Packet Radio Service Support Node and a Radio Network Controller; and
the interface is a S4 interface at a tunnel setup with General Packet Radio Service Tunnel Protocol Version 2.

8. The method according to claim 5, wherein the General Packet Radio Service Tunnel Protocol header includes one first field formed as an octet of bits and three second fields formed as octets of bits.

9. The method according to claim 5, wherein the General Packet Radio Service Tunnel Protocol header indicates a tunnel setup with General Packet Radio Service Tunnel Protocol Version 2.

10. An apparatus, comprising:
a processing means adapted to compose a General Packet Radio Service Tunnel Protocol header; and
transmission means adapted to cause transmission of the General Packet Radio Service Tunnel Protocol header to a network element,
wherein the General Packet Radio Service Tunnel Protocol header includes at least one first field comprising Tunnel Endpoint Identifier information, and at least one second field comprising extended user plane Tunnel Endpoint Identifier information.

11. The apparatus according to claim 10, wherein
the network element is a Serving General Packet Radio Service Support Node or a Gateway General Packet Radio Service Support Node; and
the interface is a Gn/Gp interface.

12. The apparatus according to claim 10, wherein the second field is the Network Protocol Data Unit number field.

13. The apparatus according to claim 10, wherein the General Packet Radio Service Tunnel Protocol header indicates a tunnel setup with General Packet Radio Service Tunnel Protocol Version 1.

14. The apparatus according to claim 10, wherein
the network element is at least one of a Serving Gateway, an Evolved Packet Data Gateway, a trusted Access Point, and a Packet Gateway; and
the interface is one of a S5/S8 interface and a S2b/S2a interface.

15. The apparatus according to claim 10, wherein
the network element is one of a Serving Gateway, a base station and a Mobility Management Entity; and
the interface is a S1-U interface at a tunnel setup via a S11 interface.

16. The apparatus according to claim 10, wherein
the network element is one of a Serving Gateway, a Serving General Packet Radio Service Support Node and a Radio Network Controller; and
the interface is one of a S4-U interface and a S12 interface at a tunnel setup via a S4-C interface.

17. The apparatus according to claim 14, wherein the General Packet Radio Service Tunnel Protocol header includes one first field formed as an octet of bits and three second fields formed as octets of bits.

18. The apparatus according to claim 14, wherein the General Packet Radio Service Tunnel Protocol header indicates a tunnel setup with General Packet Radio Service Tunnel Protocol Version 2.

19. A computer program product embodied on a non-transitory computer-readable medium, the computer program product comprising computer-executable components which, when the program is run on a processing device, are configured to carry out the method according to claim 1.

20. (canceled)
